(19) United States
(12) Patent Application Publication
(10) Pub. No.: US 2021/0230912 A1
(43) Pub. Date: Jul. 29, 2021

(54) AUTOMOTIVE LATCH INCLUDING BEARING AND DOUBLE PAWL TO FACILITATE RELEASE EFFORT

(71) Applicant: MAGNA CLOSURES INC., Newmarket (CA)

(72) Inventor: Marco TAURASI, Livorno (IT)

(21) Appl. No.: 17/160,621

(22) Filed: Jan. 28, 2021

Related U.S. Application Data
(60) Provisional application No. 62/966,656, filed on Jan. 28, 2020.

(51) Int. Cl. E05B 85/26; E05B 85/24

(52) U.S. Cl. CPC E05B 85/26; E05B 81/14; E05B 85/243

(57) ABSTRACT

A latch having a ratchet biased for release of a striker and for retaining of the striker, the ratchet having a ratchet surface, a first pawl having a pawl surface, the first pawl for holding the ratchet in an initial closed position when the first pawl is engaged with the ratchet, a second pawl for maintaining the first pawl in the initial closed position when the second pawl is engaged with the first pawl, and a bearing positioned between the first pawl and the ratchet for rotation during rotation of the ratchet and the first pawl, such that contact between the ratchet and the first pawl is facilitated by one or more contact regions between an exterior surface of the bearing and adjacent respective at least one of the pawl surface or the ratchet surface.

### CROSS-REFERENCE TO RELATED APPLICATIONS

The present application claims the benefit of previously filed U.S. Provisional Patent Application No. 62/966,656, filed Jan. 28, 2020, the contents of which are hereby incorporated by reference in its entirety herein.

### FIELD OF THE INVENTION

This present invention relates to a latch assembly for securing and unsecuring vehicle components.

### BACKGROUND

Undesirable high door latch release effort can be caused by frictional forces between ratchet and pawl engagement. It is known that the friction force on engagement between the pawl and the ratchet is directly related to a contact frictional coefficient and an automotive door seal load. Current state of the art systems for reducing friction between the ratchet and pawl can include a double pawl configuration, special low friction grease, and/or low friction plating. However, there remain disadvantages of the magnitude of release effort for these current systems, as well as undesirable noise of operation and manufacturing complexity.

Further disadvantages with current state of the art systems include required numerous different latch designs as different versioned arrangements of ratchet and pawl to suit different design constraints of latch operation depending upon the particular vehicle door configuration and latch footprint constraints. The ability to have a customizable latch design using similar ratchet and pawl components is desired, in order to match varying requirements in operational and/or footprint characteristics.

One prior art latch design is U.S. Pat. No. 5,941,579 that describes a pin slidably mounted within a guideway of a latch housing, such that the pin is positioned for rotation between a detent fork of a ratchet and a pawl of the latch. Disadvantages of this system relate to the type and magnitude of friction generated between the pin and the adjacent surfaces of the ratchet and pawl. Further, alignment of the ratchet with the pawl can be problematic for the overall operation of the latch. This art also positions the pin on the latch housing, something that can be inconvenient for different housing package designs of different automotive door/hood configurations. A further prior art latch design is U.S. Pat. No. 8,596,696 describes the implementation of a ratchet assisted by a primary pawl and a secondary pawl utilizing only sliding friction between the ratchet and the primary pawl and only sliding friction between the primary pawl and the secondary pawl.

### SUMMARY

It is an object to the present invention to provide a latch assembly to obviate or mitigate at least one of the above-mentioned problems.

One solution is to facilitate door latch release efforts by introducing a preferable friction coefficient using a ball bearing positioned between ratchet and first pawl engagement as controlled by a second pawl.

One solution is to facilitate door latch release efforts by introducing a preferable friction coefficient using a roller bearing positioned between ratchet and first pawl engagement as controlled by a second pawl.

A first aspect provided is a latch comprising: a housing having a slot for a striker; a ratchet rotationally mounted on the housing and biased for release of the striker from the slot and retaining of the striker in the slot dependent upon angular position of the ratchet with respect to the housing, the ratchet having a ratchet surface; a first pawl rotationally mounted on the housing, the first pawl having a pawl surface, the first pawl for holding the ratchet in an initial closed position when the first pawl is engaged with the ratchet; a second pawl rotationally mounted on the housing and biased into an engaged position with the first pawl, the second pawl for maintaining the first pawl in the initial closed position when the second pawl is engaged with the first pawl; and a bearing cage positioned on a body of the first pawl or on a body of the ratchet, the cage containing a bearing for rotation within the cage during rotation of the ratchet and the first pawl, such that contact between the ratchet and the first pawl is facilitated by one or more contact regions between an exterior surface of the bearing and adjacent respective at least one of the pawl surface or the ratchet surface.

A second aspect provided is a method for operating a latch comprising the steps of: releasing a second pawl rotationally mounted on a housing and biased away from a first pawl, the second pawl for maintaining the first pawl in an initial closed position when the second pawl is engaged with the first pawl and for facilitating rotation of the first pawl when the second pawl is disengaged from the first pawl; rotating the first pawl, the first pawl having a pawl surface, the first pawl for holding a ratchet in the initial closed position when the first pawl is engaged with the ratchet; rotating a bearing in a bearing cage positioned on a body of the first pawl or on a body of the ratchet, the cage containing the bearing for rotation within the cage during rotation of the first pawl, such that contact between the ratchet and the first pawl is facilitated by one or more contact regions between an exterior surface of the bearing and adjacent respective at least one of the pawl surface or a ratchet surface; and rotating the ratchet, the ratchet rotationally mounted on the housing and biased for release of a striker from the slot and retaining of the striker in the slot dependent upon angular position of the ratchet with respect to the housing, the ratchet having the ratchet surface.

A third aspect provided is a latch comprising: a housing having a slot for a striker; a ratchet rotationally mounted on the housing and biased for release of the striker from the slot and retaining of the striker in the slot dependent upon angular position of the ratchet with respect to the housing, the ratchet having a ratchet surface; a first pawl rotationally mounted on the housing, the first pawl having a pawl surface, the first pawl for holding the ratchet in an initial closed position when the first pawl is in an engaged position; a second pawl rotationally mounted on the housing, the second pawl for maintaining the first pawl in the engaged position when the second pawl is engaged with the first pawl; and a bearing positioned between the ratchet surface and the pawl surface such that contact between the ratchet and the first pawl is at one or more contact regions between an exterior surface of the bearing and adjacent respective at least one of the pawl surface or the ratchet surface.

A fourth aspect provided is a latch comprising: a housing having a slot for a striker; a ratchet rotationally mounted on the housing and biased for release of the striker from the slot and retaining of the striker in the slot dependent upon angular position of the ratchet with respect to the housing, the ratchet having a ratchet surface; a first pawl rotationally mounted on the housing, the first pawl having a pawl surface, the first pawl for holding the ratchet in an initial closed position when the first pawl is in an engaged position; a second pawl rotationally mounted on the housing, the second pawl for maintaining the first pawl in the engaged position when the second pawl is engaged with the first pawl; and a biasing element provided between the second pawl and the first pawl for biasing the first pawl towards the engaged position.

In a related aspect the biasing element urges against both the second pawl and the first pawl. The biasing element urges the primary pawl towards a ratchet holding or engaged position with the ratchet and the biasing element urges the secondary pawl towards a releasing or disengaged position from the first pawl. In a related aspect, movement of the second pawl from an engaged position with the first pawl to a disengaged position with the first pawl, decreases the bias force of the biasing element urging the primary pawl towards the ratchet holding or engaged position, to thereby reduce the resistance of rotation of the first pawl against the force acting on the first pawl through the bearing.

A fifth aspect provided is a method of constructing a latch comprising the steps of: providing a ratchet rotationally mounted on a housing having an initial closed position and a released position; providing a first pawl rotationally mounted on a housing, the first pawl having a pawl surface for holding the ratchet in the initial closed position when the first pawl is in an engaged position with the ratchet; providing a second pawl rotationally mounted on a housing, the second pawl for maintaining the first pawl in an initial closed position when the second pawl is engaged with the first pawl and for allowing rotation of the first pawl when the second pawl is disengaged from the first pawl; and providing a bearing positioned between the pawl surface and a ratchet surface, wherein disengagement of the second pawl from the first pawl allows the ratchet to rotate towards the release position and urge the bearing against the first pawl to cause rotation of the first pawl to induce rotation of the bearing.

### FIGURES

The foregoing and other aspects will now be described by way of example only with reference to the attached drawings, in which:

FIG. 1 is a perspective view of a vehicle;

FIG. 2 is a perspective view of a latch in the vehicle shown in FIG. 1;

FIG. 3 is a side view of the latch shown in FIG. 2;

FIG. 3a is a side view of a portion of the latch shown in FIG. 2;

FIGS. 4a, 4b, 4c, 4d, 4e show operation of the latch shown in FIG. 2;

FIGS. 5a, 5b show further example detail of the latch of FIG. 2.

FIGS. 6a, 6b, 6c, 6d show an alternative embodiment of the latch of FIG. 2;

FIGS. 7a, 7b, 7c, 7d show a further alternative embodiment of the latch of FIG. 2;

FIGS. 8a, 8b, 8c, 8d show a further alternative embodiment of the latch of FIG. 2;

FIG. 9 is a further embodiment of the bearing of FIG. 2;

FIG. 10 shows an alternative embodiment of the latch of FIG. 1;

FIG. 11 shows a further embodiment of the system of FIG. 2;

FIG. 12 provides an example operation of the latch of FIG. 1; and

FIG. 13 provides an example of a method of constructing the latch of FIG. 1.

### DESCRIPTION

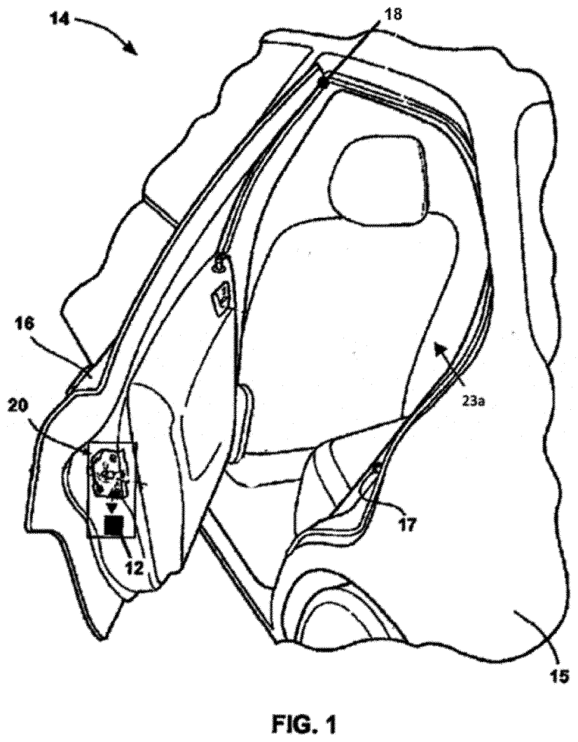

Referring to FIG. 1, shown is a vehicle 14 with a vehicle body 15 having one or more closure panels 16 coupled to the vehicle body 15. It is recognized that the closure panel(s) 16 can be as shown or can be other than as shown. For example, the closure panel 16 can be a hood 16 with hood latch 20, a door 16 with door latch 20, a trunk 16 with a trunk latch 20, a seat latch 20, etc. The closure panel 16 is connected to the vehicle body 15 via one or more hinges 18 and a latch 20 (e.g. for retaining the closure panel 16 in a closed position once closed). It is also recognized that the hinge 18 can be configured as a biased hinge 18 to bias the closure panel 16 towards an open position and/or towards the closed position. As such, the hinge 18 can also incorporate one or more actuated struts to assist in opening and closing of the closure panel 16, as desired. The closure panel 16 has a mating latch component 17 (e.g. striker) mounted thereon for coupling with the latch 20 mounted on the vehicle body 15. Alternatively, latch 20 can be mounted on the closure panel 16 and the mating latch component 17 mounted on the body 15 (see FIG. 1).

Movement of the closure panel 16 (e.g. between the open and closed panel positions) can be electronically and/or manually operated by a latch controller 12, where power assisted closure panels 16 can be found on minivans, high-end cars, or sport utility vehicles (SUVs) and the like. As such, it is recognized that movement of the closure panel 16 can be manual or power assisted (e.g. using electronic latch controller 12) during operation of the closure panel 16 at, for example: between fully closed (e.g. locked or latched) and fully open (e.g. unlocked or unlatched); between locked/latched and partially open (e.g. unlocked or unlatched); and/or between partially open (e.g. unlocked or unlatched) and fully open (e.g. unlocked or unlatched). It is recognized that the partially open configuration of the closure panel 16 can also include a secondary lock (e.g. closure panel 16 has a primary lock configuration at fully closed and a secondary lock configuration at partially open—for example for latches 20 associated with vehicle doors).

In terms of vehicles 14, the closure panel 16 may be a door, a hood, a lift gate, or it may be some other kind of closure panel 16, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening 23a in the body 15 of the vehicle 14. Also contemplated are sliding door embodiments of the closure panel 16 and canopy door embodiments of the closure panel 16, such that sliding doors can be a type of door that open by sliding horizontally or vertically, whereby the door is either mounted on, or suspended from a track that provides for a larger opening 23a for equipment to be loaded and unloaded through the opening 23a without obstructing access. Canopy doors are a type of door that sits on top of the vehicle 14 and lifts up in some way, to provide access for vehicle passengers via the opening 23a (e.g. car canopy, aircraft canopy, etc.). Canopy doors can be connected (e.g. hinged at a defined pivot axis and/or connected for travel along a track) to the body 15 of the vehicle at the front, side or back of the door, as the application permits. It is recognized that the body 15 can be represented as a body panel of the vehicle 14, a frame of the vehicle 14, and/or a combination frame and body panel assembly, as desired. It is recognized that shown by example in FIG. 1, for exemplary purposes only, is a swing door 16 as an embodiment of the closure panel 16.

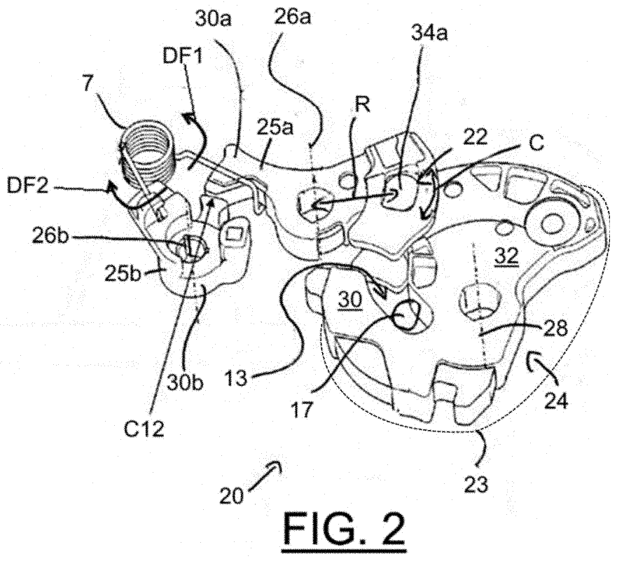

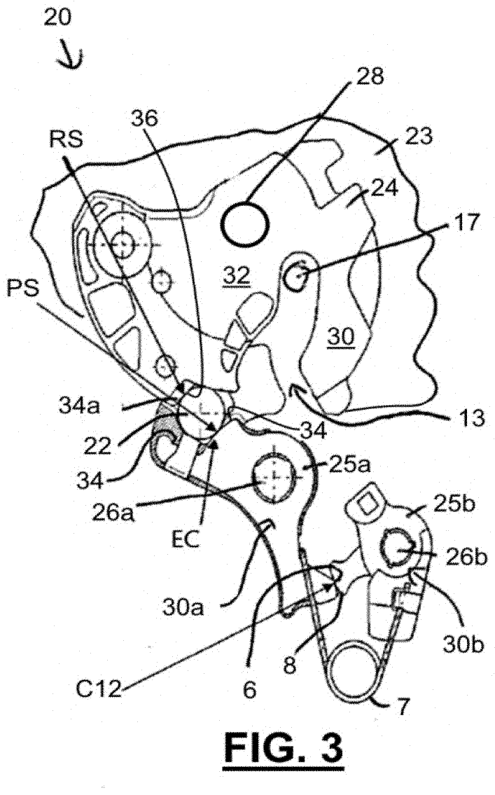

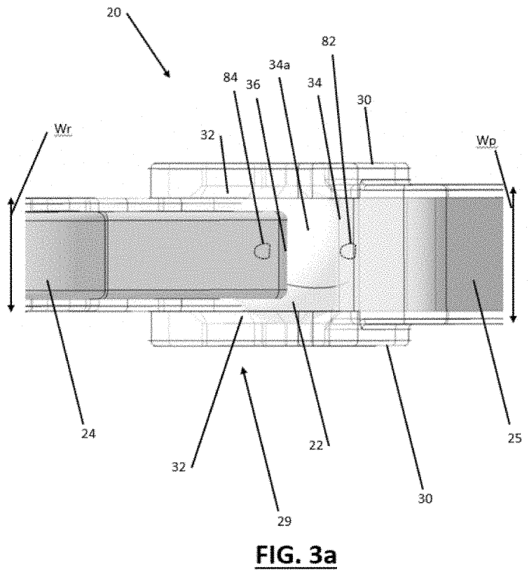

Referring to FIGS. 2, 3, the latch 20 includes a number of latch elements (e.g. ratchet 24, ball bearing 22 and first pawl 25a and second pawl 25b) that are configured to cooperate with the mating latch component 17 in order to retain the mating latch component 17 within a slot 13 when the closure panel 16 (see FIG. 1) is in the closed position (e.g. locked), or otherwise to drive the mating latch component 17 out of the slot 13 when the closure panel 16 is in the open position. The fish mouth or slot 13 is sized for receiving the mating latch component 17 therein, in other words the slot 13 of the latch 20 is configured for receiving a keeper (e.g. striker) of the mating latch component 17. The slot 13 has an open top end and a closed bottom end as shown. The latch elements of the ratchet 24 and first and second pawls 25a,b are pivotally secured to a frame plate 23 (shown by example as portion in ghosted view) via respective pivot points or pins 28,26a,b. The ratchet 24 includes an arm 30a and arm 32a spaced apart to define the generally u-shaped slot 13 there between.

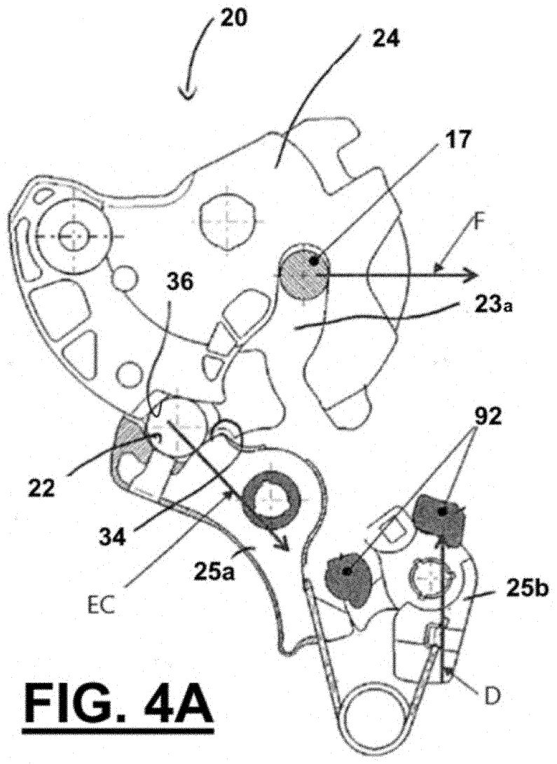

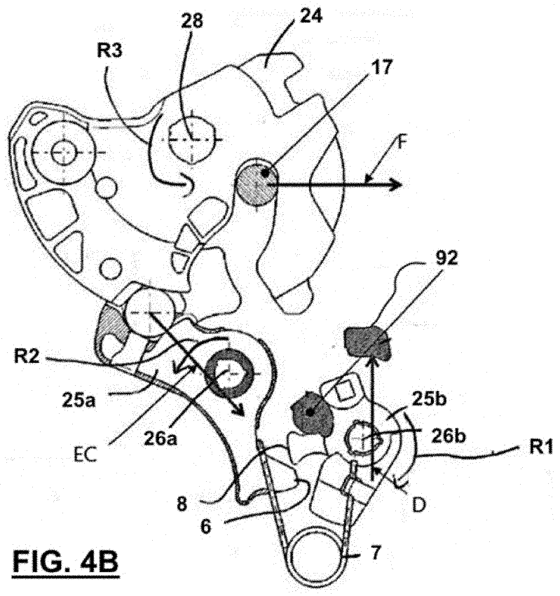

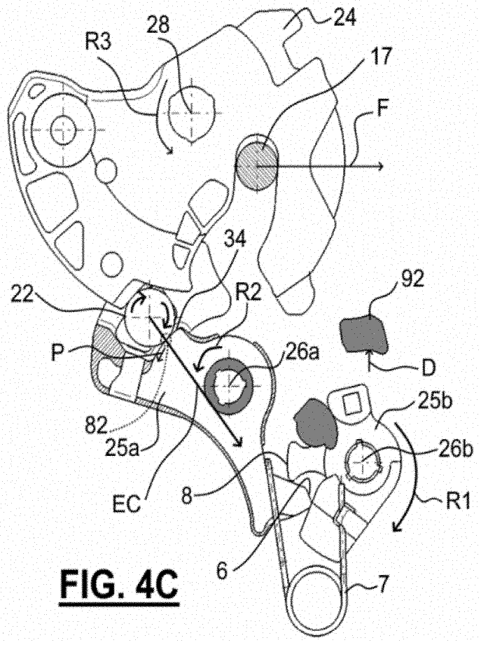

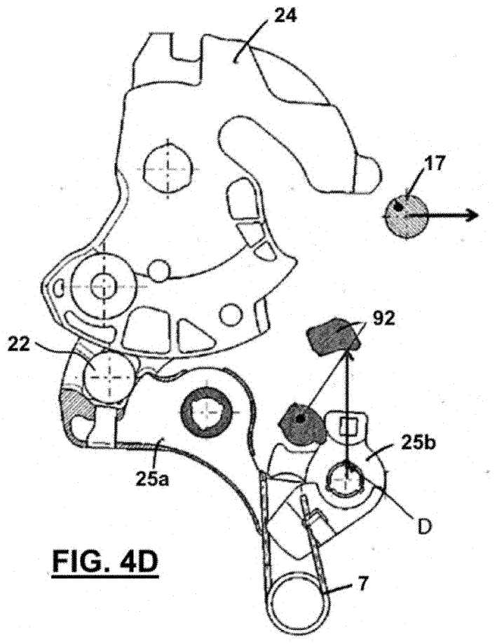

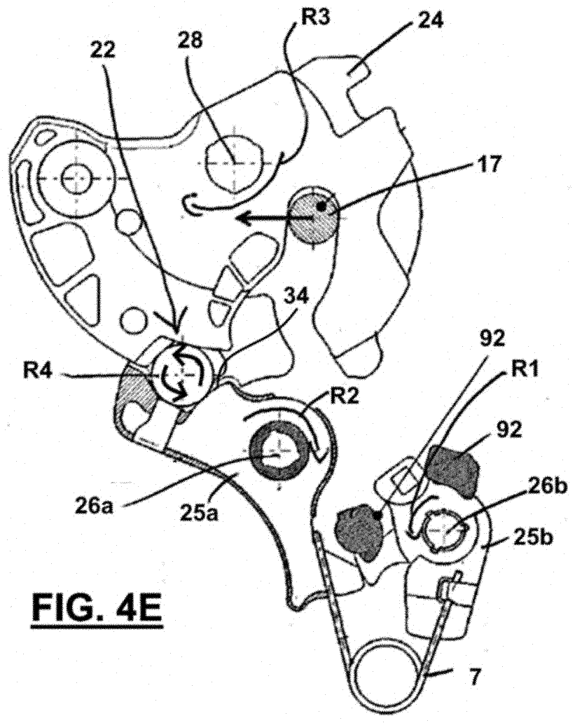

Note that in FIG. 4a the latch 20 with associated ratchet 24 are shown in the fully or primary closed position (e.g. facilitating the retention of the mating latch component 17 within the slots 13), as the latch 20 in FIG. 4bd is shown in the full open position, facilitating the release of the mating latch component from the slot 13. For example, using a hardened ball bearing 22 between the ratchet 24 and first pawl 25a can facilitate an engagement contact change from directly between the adjacent surfaces 34,36 to a desired point contact (e.g. rolling contact between an exterior surface 34a of the ball bearing 22 and the surfaces 34,36) with rolling friction less than 0.05 than what would be exhibited by sliding friction due to direct contact between the surfaces 34,36 (i.e. when no bearing 22 is positioned between the surfaces 34,36). It is recognized that surfaces 34 is of the first pawl 25a and the surfaces 36 are of the ratchet 24, such that the surfaces 34,36 are opposed to one another with the bearing 22 positioned there-between.

FIG. 4a shows the door release example there the ratchet 24 is engaged by the first pawl 25a, whereby a ball bearing 22 (e.g. sphere) is located between the first pawl 25a and the ratchet 24. It is recognized that the contact between the first pawl 25a and the sphere can have an eccentric profile surface 34 providing an eccentric component EC, such that the force F coming from the striker 17 generates a rotation component FR on the first pawl 25a in the opening direction of the closure panel 16. Further, the first pawl 25a is engaged by the second pawl 25b while the latch 20 remains in the closed state/position. Also shown is a release direction D associated with a pawl lever 92.

Referring again to FIGS. 2,3, the ball bearing 22 can be mounted to a body 30a of the first pawl 25a by cage 29 (see FIG. 3a) having a pair of sidewalls 30 positioned on either side of the ball bearing 22. The sidewalls 30 are spaced apart and opposed to one another to accommodate positioning of the ball bearing 22 there between. Each of the sidewalls 30 can have a slot 32 positioned therein for seating the ball bearing 22 within the cage 29. The slots 32 can be formed as recesses (e.g. grooves) in the sidewalls 30 and/or can be perforations (e.g. holes) in the sidewalls 30, as desired. As the ball bearing 22 is of a spherical shape, the ball bearing 22 is free to rotate in multiple rotational directions within the slots 32. For example, the slots 32 can have an arc of curvature C defined by a radius R measured from the pivot point 26a. The ball bearing 22 is also positioned between the surface 34 of the pawl 25 and the surface 36 of the ratchet 24, such that the ball bearing 22 can have one or more independent points of contact between an exterior surface 34a of the ball bearing 22 and the surface(s) 34,36. For example, the surface(s) 34,36 can be of an arcuate (e.g. concave) or angled shape (e.g. L shaped) to facilitate retaining of the ball bearing 22 between the surfaces 34,36 when the latch is in the closed position (see FIG. 2). As such the arcuate or angled shape of the surface 34 of the first pawl 25a and/or the surface 36 of the ratchet 24 can act as a cradle for the bearing 22 in order to support the bearing 22 and facilitate alignment of the bearing 22 in a desired orientation between the ratchet 24 and first pawl 25a. For example, the surface 36 of the ratchet 24 can have a corresponding surface for defining the cradle of the ratchet 24 and the surface 34 of the first pawl 25a can have a corresponding surface for defining the cradle of the first pawl 25a. A biasing element 7 (e.g. spring) can have a second direction force DF2 on the second pawl 25b and a first direction force DF1 on the first pawl 25a. Also, there is contact C12 between surfaces of the first and second pawls 25a, 25b. Further, there is contact RS between the bearing 22 and the ratchet 24, as well as contact PS between the first pawl 25a and the bearing 22.

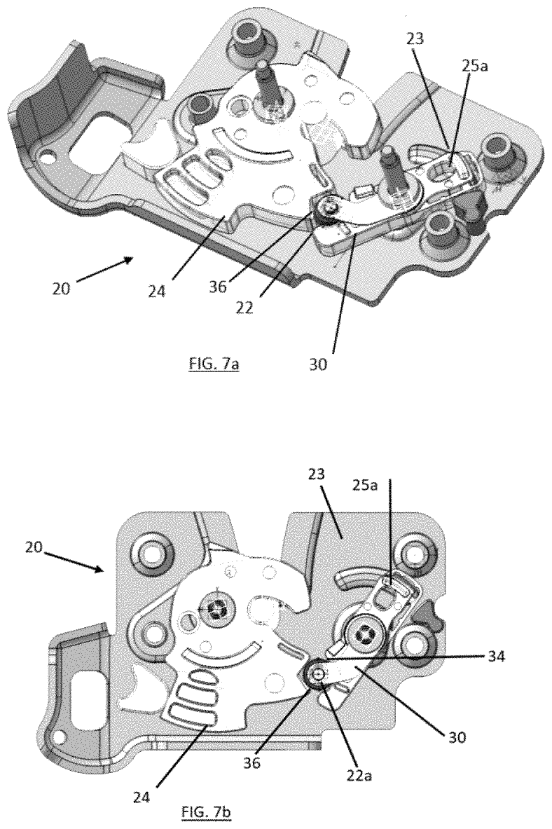

It is also noted that the contact surfaces 34,36 are at different distances as measured from a common pivot point 26a,28. As such, the first pawl 25a contact region (e.g. point) of the bearing 22 exterior surface 34a with the contact surface 34 and the ratchet 24 contact region (e.g. point) of the same bearing 22 exterior surface 34a with the contact surface 36 are at different distances relative to the same pivot point 26a,28. A consequence of these different distances is that the bearing 22 surface 34a experiences rolling or rotation along a degree of freedom accorded by the slot 32 (or other mounting type—e.g. fixed axis of rotation via a pin—see FIG. 7a,7b) along the contact surfaces 34,36, as the speed (of rotation) of each pawl contact region and ratchet contact location on the bearing 22 exterior surface 34a is also the same.

In this manner, it is recognized that the bearing 22 exterior surface 34a can travel at the same speed (e.g. matched speeds) while having multiple contact regions (on first pawl 25a and the ratchet 24) each at different distances from a common pivot point 26a,28, which therefore induces rotation of the bearing 22 afforded by the degree of freedom provided by the slots 32 or fixed rotational axis on the sidewall(s) 30 (i.e. how the bearing 22 is mounted directly to the first pawl 25a or the ratchet 24). As such, rotation is induced on the bearing 22 since the speed (rolling) along one side of the bearing 22 exterior surface 34a (adjacent to the pawl contact surface 34) is the same as the speed (rolling) along the other side of the bearing 22 exterior surface 34a (adjacent to the ratchet contact surface 36), given the different distances of each of the separate contact surface 34 and contact surface 36 from a respective same pivot point 26a or same pivot point 28.

It is noted that the sidewalls 30 can be positioned on either side of the ratchet 24, such that at least a portion of the sidewalls 30 overlap the body of the ratchet 24, so that alignment between the ratchet 24 and the first pawl 25a can be maintained during operational rotation of the first pawl 25a and ratchet 24. Further, it is recognized that at least some overlap of the sidewalls 30 with the body of the ratchet 24 can be maintained at all times during relative travel between the first pawl 25a and the ratchet 24, in order to inhibit interference in movement between the first pawl 25a and the ratchet 24.

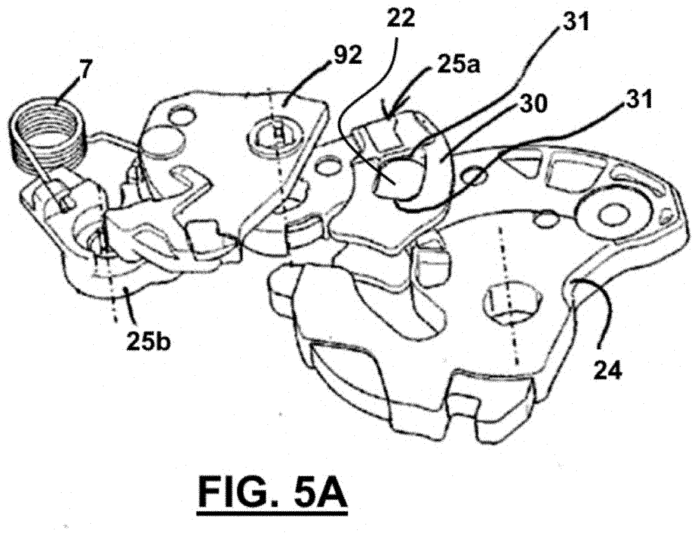

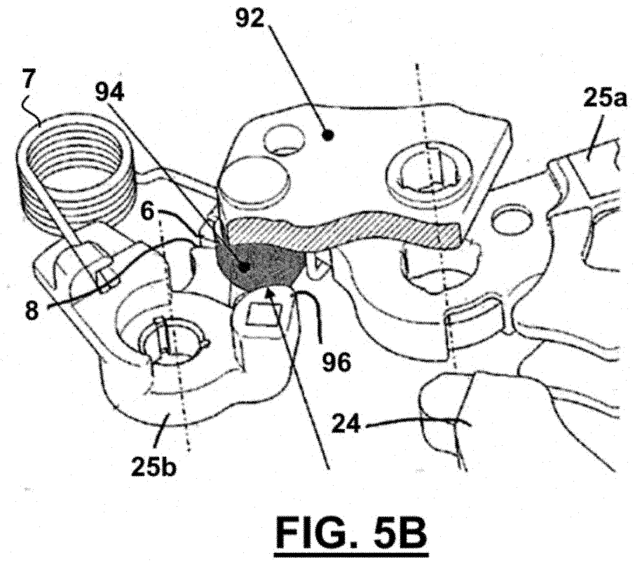

Also provided is the second pawl 25b rotationally mounted to the frame plate 23 by the pivot point or pin 26b. The first pawl 25a has a first surface 6 and the second pawl 25b has a second surface 8, such that when the first surface 6 and the second surface 8 are in contact with one another, the first pawl 25a is inhibited from rotation about the pivot point 26a. As the first pawl 25a is inhibited from rotation, the ratchet 24 is also inhibited from rotation about its pivot point 28, see FIG. 4a. Further, a biasing element 7 is used to bias out of engagement (i.e. out of contact) the first surface 6 with the second surface 8, as shown in FIG. 4b. As such, if it were not for the presence of a pawl lever 92 (see below with reference to FIGS. 4a,b), the surfaces 6,8 are biased away from one another (i.e. out of contact with one another) by the biasing element 7. Biasing element 7 may in one possible configuration be mounted or urged against the first pawl 25a at one of its spring ends (e.g. within a notch for example formed on the first pawl 25a), and be mounted or urged against at the other one of its spring ends the second pawl 25b (e.g. within a notch for example formed on the second pawl 25b). The biasing force imparted by biasing element 7 upon the first pawl 25a and/or the second pawl 25b may be dependent on the position of the first pawl 25a and the second pawl 25b relative to one another. For example, as second pawl 25b is moved from its engaged position with the first pawl 25a to its disengaged position with the first pawl 25a, the spring 7 may be compressed. e.g. the ends of the spring 7 are brought closer together, tending to increase the bias force urging the first pawl 25a towards its engaged position with the ratchet 24. Therefore, first pawl 25a is biased towards the ratchet 24, or in other words first pawl 25a is biased towards its engaged position with the ratchet 24. For example, when the ratchet 24 is released as shown in FIG. 4D, the spring 7 is compressed by the first pawl 25a in the disengaged position while the second pawl 25b is in the disengaged position. When the actuation of the second pawl 25b ceases or the actuation is reset, spring 7 will urge the first pawl 25a towards the ratchet 24, for example towards its ratchet engaged position. Each of the slots 32 of the cage 29 can have slot end abutments 31 (see FIG. 5a) for stopping travel of the bearing 22 along a length of the slot 32, when the bearing 22 reaches the end of the slot 32. For example, the slot end abutments 31 are positioned at either end of a length (e.g. arc C) of the slot 32. As such, e.g. see FIGS. 4a,b,c,d,e, the bearing 22 can travel within the slot 32 between one slot end abutment 31 and the opposing slot end abutment 31 during operation of the latch 20, as further described below. It is also recognized that the exterior surface 34a of the bearing 22 can maintain contact with both of the abutments 31, in the event that the length of the arc C is proportional to the diameter of the bearing 22, as desired, as the bearing rotates within the slots 32 as the first pawl 25a rotates about the pivot point 26a.

As discussed, movement of the bearing 22 within the slot 32 (e.g. between the slot end abutments 31) can be provided for as predominantly rolling movement, i.e. the bearing 22 is free to rotate within the cage 29 as the bearing 22 moves along surfaces 34,36—see FIGS. 4a,b,c,d,e—thereby having the exterior surface 34a of the bearing 22 predominantly experience rolling friction with respect to the surfaces 34,36 (and/or surfaces 34′,36′). An example of rolling/rotating movement of the bearing 22 can be when the bearing 22 is traveling between slot end abutments 31 (see FIG. 5a) of the slots 32. An example of translational (i.e. sliding rather than rotating) movement of the bearing 22 can be when the bearing 22 is positioned against one of the slot end abutments 31, in other words constrained from further movement along the length of the slot 32 by contact with one of the slot end abutments 31. It is recognized that the slot end abutments 31 can be positioned at the physical end of the slot 32 length or can be positioned adjacent to the physical end of the slot 32 length, as desired.

### Points or Regions of Contact 82,84

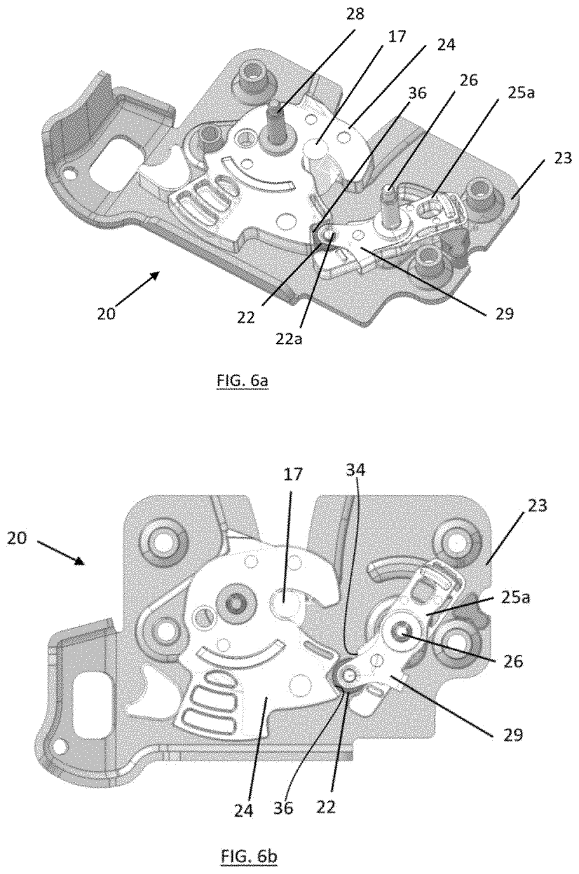

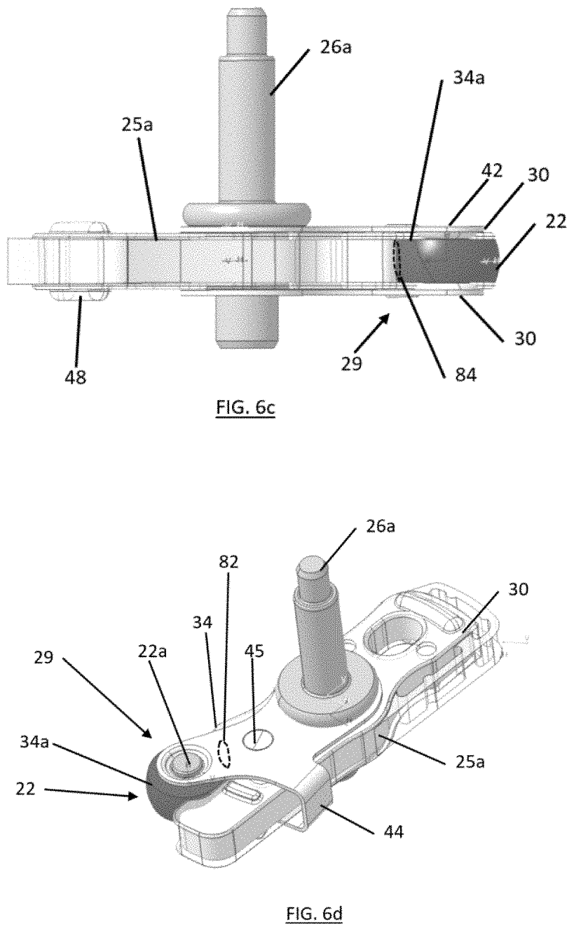

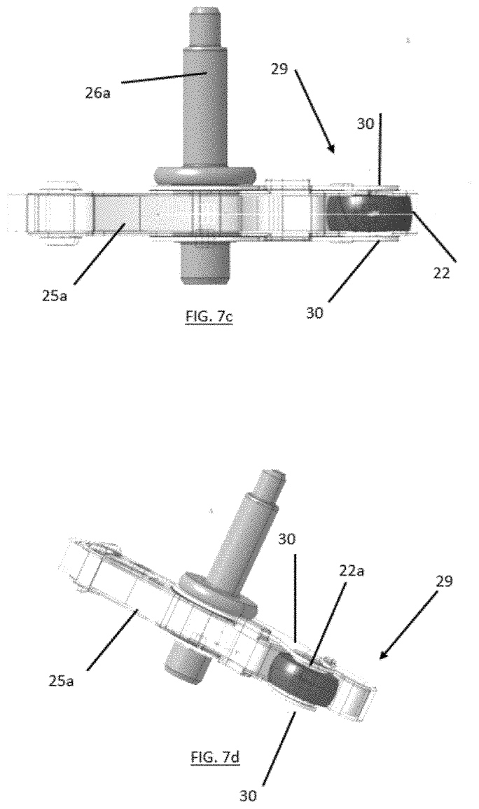

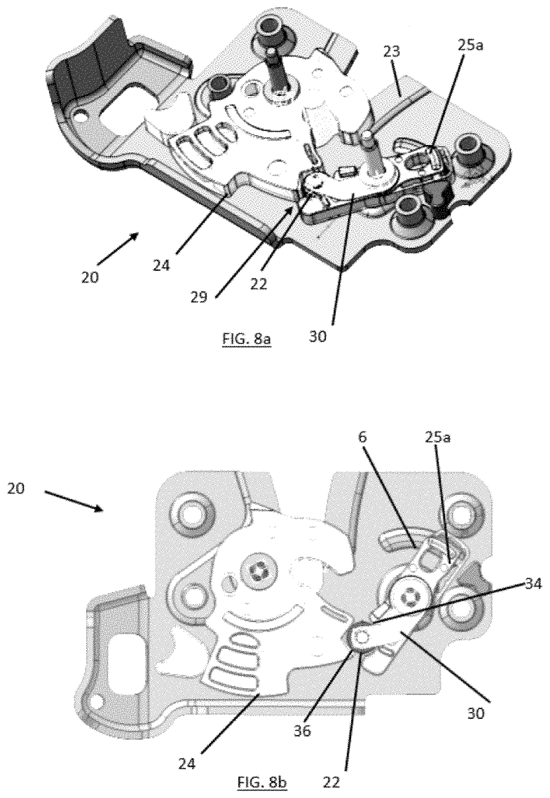

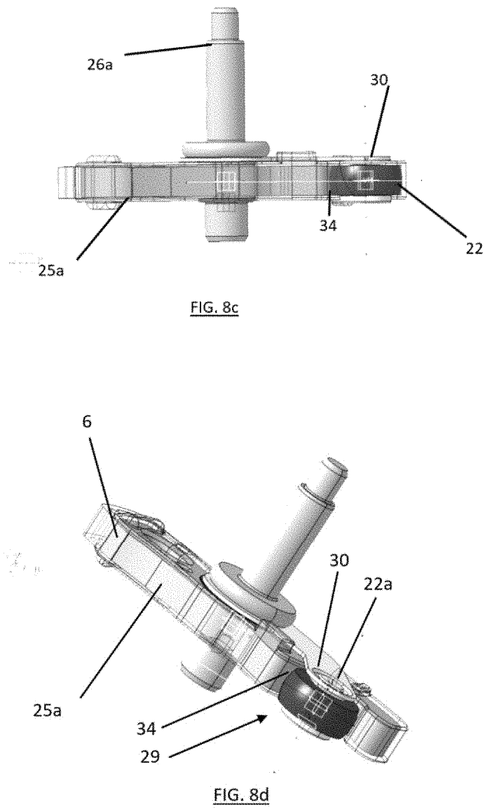

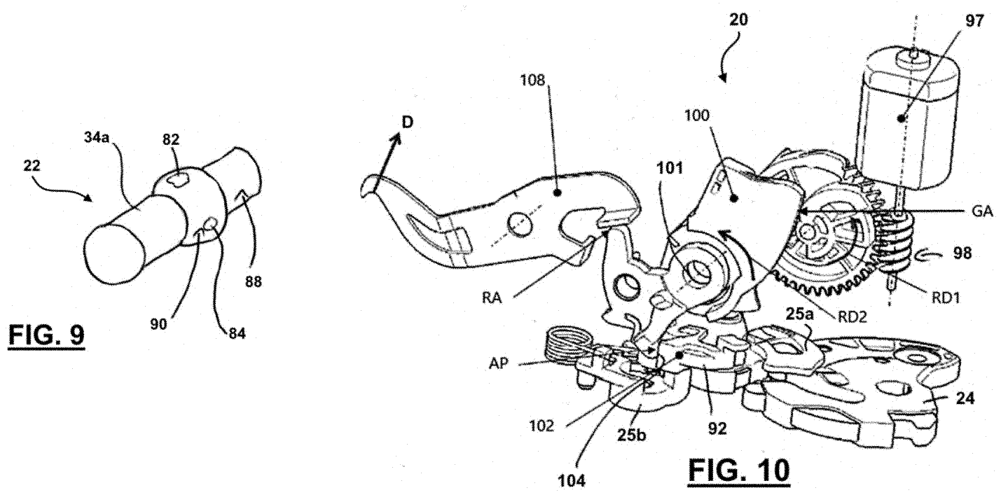

Referring to FIGS. 6a,b,c,d, FIGS. 7a,b,c,d and FIGS. 8a,b,c,d, the second pawl 25b is not shown for the sake of ease of explanation, concerning defining of the type(s) of contact between the exterior surface 34a of the bearing 22 and the surface(s) 34,36 (and/or 34′,36′) of the respective first pawl 25a and the ratchet 24.

As such, the ball bearing 22 can have one or more points (also referred to as localized region) of contact between the exterior surface 34a of the ball bearing 22 and each of the surfaces 34,36, such that for two or more points (e.g. plurality) of contact with a respective surface 34,36, each of the two or more points of contact on the same surface 34,36 are separated (i.e. distanced along the exterior surface 34a of the ball bearing 22 and therefore not considered as a line of contact) from one another. It is recognized that the point(s) of contact experienced by the ball bearing 22 are different from a line of contact provided by a roller bearing 22 (see FIGS. 6a,b,c,d). As such, it is recognized that contact between a roller bearing 22 (e.g. cylindrical bearing) and an adjacent surface 34,36 is comprised of a series of connected contact regions in the form of the line, which is different from a localized point or region of contact between the adjacent surface 34,36 and the ball bearing 22 (e.g. spherical bearing—see FIGS. 2,3). It is also recognized that a roller bearing 22 (see FIGS. 6a,b,c,d) has a single dedicated or fixed/consistent axis 22a of rotation along the length of the cylinder while the ball bearing 22 can have multiple different axes of rotation as the ball bearing 22 rotationally repositions itself within the cage 29, as the ball bearing 22 rotates during contact with the surfaces 34,36 as the ratchet 24 and first pawl 25a rotate about their shafts 28,26a.

For example, ball bearings 22 make use of hardened spherical balls that can handle both radial as well as thrust loads. Because the ball bearings 22 can be spherical, there is very small area or localized (e.g. point) of contact with the adjacent surface 34,36 and the exterior surface 34a of the ball bearing 22. Thus it is recognized that when the load is high between the surfaces, the exterior surface 34a of the ball bearings 22 can get deformed (e.g. localized flattening at the point of contact).

In comparison, roller bearings 22 (see FIGS. 6a,b,c,d) are used in applications where large load is to be borne, for example in conveyor belts where rollers must bear heavy radial loads. As the name implies, the roller is not a sphere but cylindrical in shape so that contact between the outer surface 34a of the roller and an adjacent surface is not a point but a straight line. Thus there is a greater contact than with ball bearings 22 (see FIGS. 2,3) and thus the load is spread out over a larger area allowing roller bearings 22 to bear a heavier loads than ball bearings 22.

As such, in the case of ball bearings 22, the bearings 22 are hardened spherical balls that can greatly reduce the friction between moving parts (i.e. ratchet 24 and first pawl 25a) as the area of contact is a point (or localized region) only. It is recognized that a line contact of the roller bearing 22 is a distributed area of contact, which is considered substantively different from a point which is a localized region of contact. It is also recognized that a roller bearing 22 has a dedicated or fixed axis of rotation 22a along the length of the cylinder employed during rotation of the cylindrical bearing 22, as compared to the ball bearing 22 which has a dynamic or changing axis of rotation during rotation as the ball bearing 22 is free to change the orientation of the axis of rotation within the cage 29 due to frictional and load forces generated between the exterior surface 34a of the ball bearing 22 and the surface(s) 34,36. In other words, the portion of the exterior surface 34a of the ball bearing 22 in contact with the slots 32 is free to vary during rotation, as compared to the roller bearing 22 whereby the portion of the exterior surface 34a of the roller bearing in contact with the surface 36,36′ of the ratchet 24 can be fixed (i.e. does not vary) during rotation.

The bearing 22 can be of a general cylindrical shape (e.g. cylindroid) or can be of a general spheroidal shape, recognizing that the surface 34a of the bearing 22 is of arcuate shape (i.e. convex shape bulging outward from a center or centroid of the bearing 22). It is also recognized that the bearing 22 can be a combination of cylindroid and spheroid, see FIG. 20, as desired. As such, the bearing 22 as a spheroid has the surface 34a defined as an approximately spherical body, admitting irregularities even beyond the bi- or tri-axial ellipsoidal shape defining a quadric surface obtained by rotating an ellipse about one of its principal axes; in other words, an ellipsoid (also referred to as spheroid) with two equal semi-diameters. It is recognized that a spherical shape of the surface 34a is an embodiment of the spheroidal shape, such that the surface 34a is defined as a set of points that are all at the same distance r from a given center of the bearing 22. As such, the bearing 22 as a spheroid can be defined as having a general spherical shape in which the surface 34a is defined as a set of points in which not all at the same distance r from a given center of the bearing 22. In terms of the cylindroid shape of the surface 34a, this shape can be defined as a cylinder having an ellipse as its cross section taken along a rotational axis of the bearing 22. It is recognized that a cylindrical shape of the surface 34a is an embodiment of the cylindroid shape, such that the arcuate (e.g. convex) surface 34a is defined as a set of points that are all at the same distance r from a given central axis (i.e. rotational axis) of the bearing 22. As such, the bearing 22 as a cylindroid can be defined as having a general cylindrical shape in which the arcuate surface 34a is defined as a set of points in which not all are at the same distance r from the given central axis of the bearing 22. In terms of the cylindroid bearing 22 embodiment, the arcuate surface 34a rotates about a defined and consistent central axis 22a during rotation between surfaces 34,36. In terms of the spheroidal bearing 22 embodiment, the arcuate surface 34a rotates about a central point and therefore has a dynamically changing axis of rotation during rotation between surfaces 34,36.

In terms of the spheroidal bearing 22 embodiment, the arcuate surface 34a contacts the surface 34 at a contact region 82 (e.g. a point or other localized finite surface area) and the surface 36 at a contact region 84 (e.g. a point or other localized finite surface area), shown in ghosted view in FIG. 3a, such that a width of the contact region 82 is less than a width Wp of the first pawl 25a (e.g. less than the width of the contact or cam surface 34) and a width of the contact region 84 is less than a width Wr of the ratchet 24 (e.g. less than the width of the contact or cam surface 36). It is recognized that the contact regions 82, 84 are a portion of the spheroidal surface 34a. It is also recognized that the measured width (e.g. diameter) of the bearing 22 extending between the sidewalls 30 of the cage 29 can be greater than or less than the width (Wp) of the body of the first pawl 25a and/or the width (Wr) of the body of the ratchet 24, as long as the surface 34a of the bearing is contained by the sidewalls 30 within the opposed slots 32. Shown by example is where the width of the bearing 22 is greater than both the width Wp of the first pawl 25a body 30a and the width Wr of the ratchet 24 body 24a (e.g. the widths of the contact or cam surfaces 34,36 respectively). Further, the width of the contact regions 82,84 are less than the measured width of the bearing 22 with respect to the sidewalls 30. It is recognized that in the case where the sidewalls 30 (see FIG. 2) hold the bearing 22 such that contact between the arcuate surface 34a and the surface 34 is inhibited, contact region 82 would be optional. Further, in the case where the sidewalls 30 (see FIG. 2 for example) when mounted on the ratchet 24 hold the bearing 22 such that contact between the arcuate surface 34a and the surface 36 is inhibited, contact region 84 would be optional.

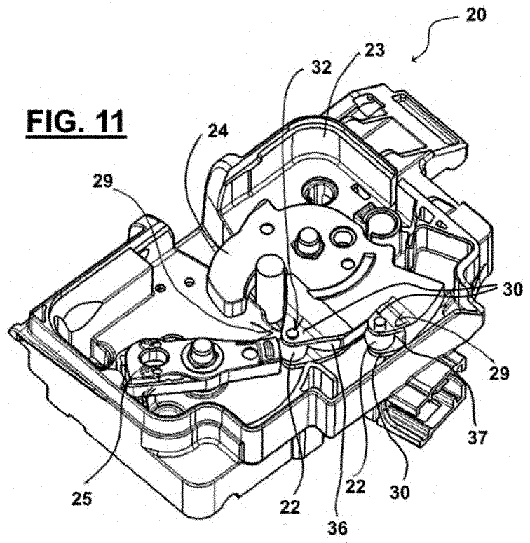

See FIG. 11 for an example where the cage 29 is mounted on a body of the ratchet 24, recognizing that the sidewalls 30 can contain the slot 32 that provides a fixed mounting location of the bearing 22 providing a fixed location axis of rotation 22a, or can provide a variable mounting location of the ball bearing 22 providing a variable positioned axis of rotation. As such, concerning the embodiment shown in FIG. 11, the bearing 22 can be a ball bearing 22 located within a cage 29 (not shown) or can be a roller bearing 22 mounted on a fixed axis of rotation 22a to the body 24a of the ratchet 24, as desired.

Further, it is recognized that the contact regions 82,84 can be defined as a a spheroidal sector (i.e. a portion of the spheroidal surface 34a) defined by a conical boundary with apex at the center of the spheroid. The spheroidal sector (i.e. contact region 82,84) can be described as a union of a spheroidal cap and a cone formed by a center (or centroid) of the spheroid and a base of the cap. For example, if the radius of the spheroid (e.g. sphere) is denoted by r and the height of the cap by h, the surface area of the spheroidal (e.g. spherical) sector is 2(Pi)rh. It is recognized that for a spheroid, the radius r may be an average radius of all points defining the arcuate surface 34a and the height h may be an average height for all points of the cone on the arcuate surface 34a.

In terms of the cylindroid bearing 22 embodiment, the arcuate surface 34a (see FIG. 6a,b,c,d) contacts the surface 34 at a contact region 82 (e.g. a line or other elongated finite surface area) and the surface 36 at a contact region 84 (e.g. a line or other elongated finite surface area), shown in ghosted view in FIG. 6c,d, such that a width of the contact region 82 is the same as the width Wp of the first pawl 25a (e.g. the width of the contact or cam surface 34) and a width of the contact region 84 is the same as the width Wr of the ratchet 24 (e.g. the width of the contact or cam surface 36). It is recognized that the contact regions 82, 84 are a portion of the cylindroid surface 34a in contact with the surfaces 34,36, extending between one side of the bearing 22 and the other side of the bearing 22 as measured along the central rotational axis 22a of the bearing 22. It is recognized that the rotational axis 22a of the bearing 22 may be longer than the widths Wp, Wr. It is also recognized that the measured width (e.g. length) of the bearing 22 extending between the sidewalls 30 of the cage 29 can be greater than or less than the width (Wp) of the body of the pawl 25 and/or the width (Wr) of the body of the ratchet 24, as long as the surface 80 of the bearing is contained by the sidewalls 30 within the opposed slots 32. Shown by example is where the width of the bearing 22 is greater than both the width Wp of the pawl 25 body and the width Wr of the ratchet 24 body. It is recognized that in the case where the arms 30 (see FIG. 6c) hold the bearing 22 such that contact between the arcuate surface 80 and the surface 34 is inhibited, contact region 82 would be optional. Further, in the case where the arms 30 (see FIG. 6c for example) when mounted on the ratchet 24 hold the bearing 22 such that contact between the arcuate surface 80 and the surface 36 is inhibited, contact region 84 would be optional.

It is also recognized that the bearing 22 as a cylindroid (e.g. cylinder) can be mounted in the cage 29, whereby at least a portion of the surface 34a has mounted (or formed) thereon an exterior surface 34a defined as having character as spheroidal (e.g. spherical). As such, it is recognized that even the bearing 22 having a cylindrical/cylindroid main body 88 can have a portion of the exterior arcuate surface 34a being spheroidal (e.g. spherical) 90, see FIG. 20, such that the spheroidal surface 90 contains the contact regions 82,84 as discussed above.

Referring to FIG. 4a, shown is the bearing 22 positioned between surfaces 34,36 when the latch 20 is in the initial primary latched position, such that the mating latch component 17 is retained by the slot 13 of the ratchet 24. Not shown is the cage 29 for purposes of illustration only, however recognizing that in FIG. 4a the bearing 22 can be positioned at the one slot end abutment 31 (e.g. slot end abutment 31 furthest from the surface 36 of the ratchet 24), as shown in FIG. 2, when the first pawl 25a and the second pawl 25b are in their initial latched positions. Also shown is a pawl lever 92, which inhibits movement (i.e. rotation) of the second pawl 25b about the pivot point 26b when the pawl lever 92 is in contact with a second body 30b of the second pawl 25b.

Referring to FIG. 4b, as the pawl lever 92 is removed from contact with the second pawl 25b, this provides for rotation R1 of the second pawl 25b about the pivot point 26b, thus disengaging the surfaces 6,8 and thus actuating the second pawl 25b in the release direction D. Accordingly, since surfaces 6,8 are disengaged, the first pawl 25a is free (i.e. uninhibited by the second pawl 25b) to start rotation R2 about the pivot point 26a while thus providing for the start of rotation R3 of the ratchet 24 about the pivot point 28. In FIG. 4b, the rotations R2,R3 are about to begin as shown.

Referring to FIG. 4c, the rotations R2,R3 are shown, such that the rotation R4 of the bearing 22 is induced due to contact of the surface 34a with the surfaces 34,36. As the bearing 22 is forced against the first pawl 25a by the rotation of the ratchet 24 in the direction R3 following release, or after the secondary pawl 25b is disengaged from the first pawl 25a, the translation of the bearing 22 (or non-rotational translationl) as moved by the rotation of the ratchet 24 urges the bearing 22 against the first pawl 25a and will cause the rotation of the first pawl 25a (R2), and for example against the bias of spring 7. Motor 97 has no further influence on the rotation of the first pawl 25a after moving secondary pawl 25b and does not contribute to assist or resist motion of the first pawl 25a. Rotation of the first pawl 25a about pivot 26a as caused by the bearing 22 urging against the first pawl 25a will induce rotation of the bearing 22. For example the rotation of the first pawl 25a in the direction R2 will cause a movement of the surface 34 relative to the bearing 22 in the direction shown by arrow P causing a drag force on the bearing 22 at the contact region 82 to cause the bearing 22 to rotate. As bearing 22 travels along pawl surface 34 while undergoing rotation, for example along an eccentric profile of surface 34, eccentric component EC may shift further away from pivot 26a further increasing rotation of first pawl 25a and inducement of rotation of bearing 22. Referring to FIG. 4c, as the first pawl 25a is actively released (e.g. by movement of the second pawl 25b about the pivot 26b in order to disengage the surfaces 6,8), the bearing 22 is free to rotate R4 within the cage 29 (see FIG. 2) and thus the exterior surface 34a of the bearing 22 can experience rolling friction again the surfaces 34,36 of the first pawl 25a and the ratchet 24 respectively. It is recognized that during rotation the bearing 22 can be located in the slots 32 away from both of the opposed slot end abutments 31, i.e. the bearing 22 is in the process of travelling from one end 31 of the slot 32 (e.g. slot end abutment 31 furthest from the surface 36 of the ratchet 24) to the other end 31 (e.g. slot end abutment 31 closest to the surface 36 of the ratchet 24) of the slot 32 (see FIG. 2). Not shown in FIGS. 4a,b,c,d is the cage 29 for purposes of illustration only.

Referring to FIG. 4d, shown is the mating latch component 17 released from the slot 13 of the ratchet 24, placing the latch 20 in the open position.

FIG. 4e shows the latch 20 placed back into the latched position, when the release actuator has been driven back and/or associated mechanical handles have been released, such that the mating latch component 17 is repositioned in the slot 13 and thus retained therein. Further, the rotations R1, R2, R3, R4 are in opposite direction to those shown in FIGS. 4b,c. In sequence, going from the open position of FIG. 4d to the closed or latched position of FIG. 4e, first the mating latch component 17 enters into the slot 13 and thus rotates R3 the ratchet 24. Rotation R3 of the ratchet 24 causes rotation R4 of the bearing 22 and thus concurrent rotation R2 of the first pawl 25a. The ratchet 24 and first pawl 25a continue to rotate R2,R3 until the first pawl 25a reaches its initial latched position (as shown also by example in FIG. 4a). Once in the initial latched position (for the first pawl 25a), the pawl lever 92 is returned and thus forces the rotation R1 of the second pawl 25b (about the pivot point 26b) against the bias of the biasing element 7 until the surfaces 6,8 are engaged with one another.

In view of the above, a method for operating a latch 20 can comprising: releasing a second pawl 25b rotationally mounted on a housing 23 and biased away from a first pawl 25a, the second pawl 25b for maintaining the first pawl 25a in the initial closed position, or engaged position, when the second pawl 25b is engaged with the first pawl 25a and for facilitating rotation of the first pawl 25a when the second pawl 25b is disengaged from the first pawl 25a; rotating the first pawl 25a, the first pawl 25a having a pawl surface 34, the first pawl 25a for holding a ratchet 24 in the initial closed position when the first pawl 25a is engaged with the ratchet 24; rotating a bearing 22 in a bearing cage 29 positioned on a body 30a of the first pawl 25a or on a body of the ratchet 24, the cage 29 containing the bearing 22 for rotation within the cage 29 during rotation of the first pawl 25a, such that contact between the ratchet 24 and the first pawl 25a is facilitated by one or more contact regions 82,84 between an exterior surface 34a of the bearing 22 and adjacent respective at least one of the pawl surface 34 or a ratchet surface 36; and rotating the ratchet 24, the ratchet 24 rotationally mounted on the housing 23 and biased (for example in the direction R3 as shown in FIG. 4b), such as by use of a ratchet spring, for release of a striker 17 from a slot 13 and retaining of the striker 17 in the slot 13 dependent upon angular position of the ratchet 24 with respect to the housing 23, the ratchet 24 having the ratchet surface 36.

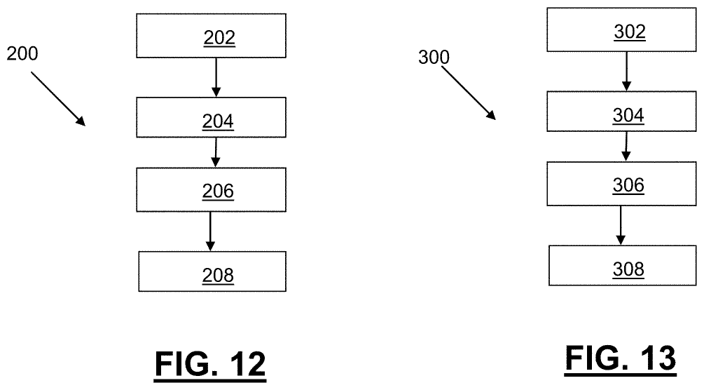

Referring to FIG. 12, shown is a method 200 for operating a latch 20 comprising the steps of: releasing 202 a second pawl 25b rotationally mounted on a housing 23, the second pawl 25b for maintaining a first pawl 25a in an initial closed position when the second pawl 25b is engaged with the first pawl 25a and for allowing rotation of the first pawl 25a when the second pawl 25b is disengaged from the first paw 25a; rotating 204 the first pawl 25a, the first pawl 25a having a pawl surface 34 the first pawl 25a for holding a ratchet 24 in the initial closed position when the first pawl 25a is in an engaged position with the ratchet 24; rotating 206 a bearing 22 positioned between the pawl surface 34 and a ratchet surface 36 of the ratchet 24, during rotation of the first pawl 25a, such that contact between the ratchet 24 and the first pawl 25a is by one or more contact regions 82,84 between an exterior surface 34a of the bearing 22 and adjacent respective at least one of the pawl surface 34 or the ratchet surface 36; and rotating 208 the ratchet 24, the ratchet 24 rotationally mounted on the housing 23 and biased for release of a striker 17 from a slot 13 and retaining of the striker 17 in the slot 13 dependent upon an angular position of the ratchet 24 with respect to the housing 23. The method 200 can further including rotating the first pawl 25a as a result of a force FR (see FIG. 4b) imparted on the first pawl 25a by the bearing 22 caused by the ratchet 25 acting on the bearing 22 during rotating when the second pawl 25b is disengaged from the first paw 25a. The method 200 can further include inducing rotation of the bearing 22 along the pawl surface 34 caused by the rotating of the first pawl 25a.

Referring additionally to FIG. 13, there is shown an illustrative method 300 of constructing a latch comprising the steps of: providing a ratchet rotationally mounted on a housing having an initial closed position and a released position 302; providing a first pawl rotationally mounted on a housing, the first pawl having a pawl surface for holding the ratchet in the initial closed position when the first pawl is in an engaged position with the ratchet 304; providing a second pawl rotationally mounted on a housing, the second pawl for maintaining the first pawl in an initial closed position when the second pawl is engaged with the first pawl and for allowing rotation of the first pawl when the second pawl is disengaged from the first pawl 306; and providing a bearing positioned between the pawl surface and a ratchet surface 308, wherein disengagement of the second pawl from the first pawl allows the ratchet to rotate towards the release position and urge the bearing against the first pawl to cause rotation of the first pawl to induce rotation of the bearing.

Further to the above, the latch 20 components can include a number of biasing elements (for example springs), such as ratchet biasing element (not shown) that biases rotation R3 of the ratchet 24 about the shaft 28 to drive the mating latch component 17 out of the slot 13 (thus moving the closure panel 16 towards the open position), and optionally first pawl biasing element (not shown) that biases rotation of the first pawl 25a about the shaft 26a to retain the ratchet 24 in the closed position (i.e. restrict rotation of the ratchet 24 about the shaft 28 under the influence of the ratchet biasing element).

In view of the above and below presented embodiments of the latch 20, for example, features of the embodiments can include: bearing 22 for facilitating reductions in release effort as described; lower closing noise as compared to surface to surface 34,36 predominantly sliding contact; custom component sizing for ratchet 24 and first pawl 25a based on geometry of the housing 23 (e.g. frame plate 23) and bearing 22; preferable inertial loading capacity along with mounting points of the housing 23 determined by design; a balanced first pawl 25a facilitating lower relative noise lock/unlock with or without power release; lower relative mass of latch components (e.g. first pawl 25a and ratchet 24) with bearing 22 inclusion as compared to non-bearing latch designs due to the presence of rolling contact in the latch 20; can be utilized in a vertical double lock child lock or other SMA power release actuator (see controller 12 of FIG. 1); flexible cable routing along with printed circuit board traces; magnetic stop bumpers; and/or spring loaded bumpers as desired.

Characteristics of the latch 20 embodiments described can include: 1) using bearing 22 on ratchet 24 (fork) and/or first pawl 25a (detent); 2) using bearing 22 inside primary or auxiliary door latch 20 design to facilitate reduced release effort as compared to direct engagement of first pawl 25a and ratchet 24 abutment surfaces 34,36; 3) slot 32 design on first pawl 25a (detent) encapsulation of the cage 29 or use of arm(s) 30 with pin (e.g. fixed axis of rotation 22a) to keep the bearing 22 positioned between the surfaces 34,36 as well as to facilitate rotation of the bearing 22 in position during rotation of the latch components (e.g. first pawl 25a and ratchet 24); 4) ratchet 24 (folk) primary and secondary profile for any usage of sphere/cylinder share contact; 5) using the bearing 22 inhibits issues of alignment between catch and detent (multi-planar ability); 6) manipulating the bearing 22 location and the catch tooth profile to can reduce energy release (pop-off) noise; and 7) improved load bearing and reduced wear capacity provided by bearing 22 and surface 34,36 contact. Also considered is use of the second pawl 25b to reduce release timing and forces between the first pawl 25a and the ratchet 24, as desired.

Example design examples of the ball bearing 22 can include: fit optimal gold cube package; 8.0 mm hardened ball instead of roller; ease of assembly due to facilitation of alignment via cage 29 and ball bearing 22 assembly; and/or use of harder plastic (PPA 30GF) for 2nd mold encapsulation. Similarly, example design examples of a roller bearing 22 (see FIGS. 6a, 7a, 8a) can include: hardened roller instead of ball; ease of assembly due to facilitation of alignment via arm(s) 30 (e.g. acting as a cage) and bearing 22 assembly; and/or use of harder plastic (PPA 30GF) for 2nd mold encapsulation. As shown in FIGS. 6a,6b,6c, the arms 30 are mounted on the pivot point 26b (same as the body 30a of the first pawl 25a), in order to facilitate rotation R4 (see FIG. 4b) of the exterior surface 34a of the bearing 22 as the ratchet 24 and the first pawl 25a rotate R2,R3 about their respective pivot points 28, 26a.

Referring to FIG. 5a,b, shown is an example pawl lever 92 for inhibiting rotation of the second pawl 25b about the pivot point 26b when the second pawl 25b is in the initial latched position (see FIG. 4a). For example, the pawl lever 92 can have a cam 94 positioned in contact with a pawl abutment 96, in order to resist the bias of the biasing element 7 (biasing the surfaces 6,8 out of engagement with one another).

FIG. 10 shows an embodiment of the latch 20 as an elatch under the control of the controller 12 (see FIG. 1). The controller 12 operates a motor 97 for driving gears 98 in order to operate an actuator lever 100, with contact GA therebetween for providing a power release or motorized function of the latch 20. The actuator lever 100 has an actuator abutment 102 in contact with an abutment surface 104 of the pawl lever 92. Thus in operation of the motor 97, the actuator lever 100 is rotated about pivot 101 and thus moves the pawl lever 92 out of contact with the second pawl 25b by pushing the actuator abutment 102 against the abutment surface 104 and thus moving the second pawl 25b (rotated about the pivot point 26b—see FIG. 4b) to cause the surfaces 6,8 to disengage from one another. Further, the latch 20 can (e.g. also) have a mechanical release lever 108, in order to actuate the actuator lever 100 about the pivot 101, for providing a manual release or non-motorized function of the latch 20. The release direction RD1 of the actuator lever 100 and the release direction RD2 of the gears 98 are shown. Contact AP between the actuator lever 100 and the pawl lever 92 is shown. Contact RA between the release lever 108 and the actuator lever 100 is shown. Motor 97 may be a direct current brushed motor for example, but other types of powered actuation devices such as a brushless motor, or an electromagnetic motor or drive may be provided. In another possible configuration, motor 97 as an electromagnetic drive, such as a solenoid, or direct drive motor assembly, may move either the lever 100, or the pawl lever 92, without the use of gears, (such as in a direct drive configuration), such as driving gears 98; gear reduction is not required since motor 97 only has to overcome the friction between first surface 6 and the second surface 8.

Referring to FIGS. 6a,6b, shown is the further embodiment of the latch 20 including a number of latch elements (e.g. the ratchet 24, the roller bearing 22 and the pawl 25) that are configured to cooperate with the mating latch component 17 in order to retain the mating latch component 17 within the slot 13 when the closure panel 16 (see FIG. 1) is in the closed position (e.g. locked), or otherwise to drive the mating latch component 17 out of the slot 13 when the closure panel 16 is in the open position. The latch elements of the ratchet 24 and first pawl 25a are pivotally secured to the frame plate 23 via respective shafts or pins 28,26a. For example, using a hardened roller bearing 22 between the ratchet 24 and first pawl 25a can facilitate an engagement contact change from directly between the adjacent surfaces 34,36 to a desired line contact (i.e. rolling contact between the exterior surface of the roller bearing 22 and the surfaces 34,36) with rolling friction less than what would be exhibited by sliding friction due to direct contact between the surfaces 34,36 (i.e. when no roller bearing 22 is positioned between the surfaces 34,36). Motor 97 may therefore be part of a configuration whereby motor 97 only is operated to move secondary pawl 25b out of disengagement with the first pawl 25a at contact C12, and motor 97 is not configured to further act either directly or indirectly on first pawl 25a after or during moving the secondary pawl 25b to its released position to increase a force on the first pawl 25a in a disengaged position, since bearing roller bearing 22 ensures friction forces between the first pawl 25a and the second pawl 25b are reduced by providing rolling frictional contact to allow first pawl 25a to move away from its engaged position with the ratchet 24 under a force acting on the first pawl 25a through the bearing 22 which originates by the rotation of the ratchet 24 caused either by influence of a ratchet spring acting on the ratchet 24, and/or by a seal load tending to pull the striker 17 (for example as shown as force F coming from the striker 17 of FIG. 4b) to rotate the ratchet 24. Similarly, mechanical release lever 108 may therefore be part of a configuration whereby mechanical release lever 108 is only manually actuated to move secondary pawl 25b out of disengagement with the first pawl 25a at contact C12, and mechanical release lever 108 is not configured to further act either directly or indirectly on first pawl 25a after or during moving the secondary pawl 25b to its released position to increase a moving force against first pawl 25a. No additional or subsequent motorized or manual user originating actuation of the first pawl 25a is required to ensure release of the first pawl 25a from the ratchet 24 in the event either ratchet biasing spring or seal load is insufficient to rotate the ratchet 24 after the secondary pawl 25b has been disengaged from the primary pawl 25a. For example, neither the pawl lever 92 nor the second pawl 25b may act on the first pawl 25a to assist the first pawl 25a to move away from its engaged position with the ratchet 24 when the second pawl 25b is in the disengaged position.

It is recognized that roller bearing 22 of FIG. 6a,6b,6c can be substituted for ball bearing 22 shown in FIGS. 2,3, such that the sides of the roller bearing 22 cooperate with slots 32 in arm(s) 30 (similar to the sidewall(s) 30 of FIG. 2) so as to guide the roller bearing 22 from one slot end abutment 31 to the other slot end abutment 31, as the first pawl 25a is rotated R2. For simplicity, the term arm(s) 30 can refer to sidewall(s) 30 or vice versa. As such, the cage 29 can be composed of one or multiple (e.g. two) arm(s) 30 or sidewall(s) 30 and the mounting of the bearing 22 to the arm(s) 30/sidewall(s) 30 can be via the slot 32 (for both the spheroid or cylindroid shaped bearing 22) and/or a mounting pin 22a representing the fixed axis of rotation 22a (for the cylindroid bearing 22). As such, it is recognized that the mounting pin 22a can be slidably received within the slots 32 positioned on either side of the roller bearing 22, as desired. As such, the roller bearing 22 can experience both sliding friction and rolling friction similar to the ball bearing 22 shown and described by example in FIGS. 2,3.

Referring to FIG. 6c, shown is a pair of arms 30 (also referred to as sidewall(s) 30 in FIG. 2) attached to either side of the first pawl 25a (e.g. at shaft 26a) for holding the roller bearing 22. For example, in the case where the arm(s) 30 are only coupled to the frame plate 23 by the pivot point 26a, rotation of the arm(s) 30 can be decoupled from rotation of the body 30a of the first pawl 25a also about the pivot point 26a. In this manner, the rotation of the arm(s) 30 and the body 30a may not always be concurrent (e.g. simultaneous) with one another.

The roller bearing 22 is positioned between the arms 30 and mounted thereto by a mounting pin 22a acting as a fixed axis of rotation for the roller bearing 22, the mounting pin 22a projecting between the pair of arms 30 on either side of the body of the first pawl 25a. The arms 30 can be optionally connected directly to one another by a connection member 44 that is separate from the pin 26a and body 30a of the first pawl 25a. For example, the arms 30 can be connected to the body 30a of the first pawl 25a by a connector 45 (e.g. screw) that is separate from the pin 26a. Similar to the preceding embodiments referred to in FIGS. 1 to 2, the roller bearing 22 in the alternative embodiments of FIGS. 6a,7a,8a can be positioned such that the roller bearing 22 can have a plurality of contacts between the exterior surface 34a of the roller bearing 22 and the surface(s) 34,36.

For example, the surface(s) 34,36 can be of an arcuate (e.g. concave) or angled shape (e.g. L shaped) to facilitate retaining of the roller bearing 22 between the surfaces 34,36 when the latch is in the closed position (see FIG. 6b). As such the surface 34 of the first pawl 25a can act as a cradle for the roller bearing 22 in order to support the bearing 22 and facilitate alignment of the roller bearing 22 in a desired orientation between the arms 30 (or extending from a single arm 30 as per FIG. 8a,b,c,d). Further, the arrangement of the pin 22a and arm(s) 30 can be referred to as a cage 29 to orient contact of the roller bearing 22 to have a plurality of contacts with the surface 34 of the first pawl 25a and/or the surface 36 of the ratchet 24. An advantage of using the arm(s) 30, pin 22a and roller bearing 22 arrangement to address friction levels between the ratchet 24 and the first pawl 25a contact is that the dimensional characteristics of the arm(s) 30, the pin 22a and/or the roller bearing 22 can be varied to match different dimensions/orientations/positioning of various ratchet/pawl designs. As such the use of the arm(s) 30, pin 22a and roller bearing 22 arrangement can be easily adapted for different configurations of ratchet/pawl for encountered in various latch 20 configurations.

In terms of the embodiments of FIGS. 6a,7a,8a, it is recognized that the roller bearing 22 can be a roller bearing such that the plurality of contacts experienced by the bearing 22 are lines of contact provided. As such, it is recognized that contact between a roller bearing 22 (e.g. cylindrical bearing 22) and an adjacent surface 34,36 is comprised of a series of connected contact regions in the form of a line, which is different from a localized point or region of contact between the adjacent surface 34,36 and the ball bearing 22 (e.g. spherical bearing 22) shown in FIGS. 2,3. It is also recognized that the roller bearing 22 has a single dedicated axis of rotation (e.g. along pin 22a) along the length of the cylinder.

Referring to FIGS. 7a, 7b, 7c, 7d, shown is an alternative embodiment of the latch 20 having a pair of independent arms 30 for positioning the roller bearing 22 between the surfaces 34,36. Similarly to the embodiment shown in FIG. 6a, the arms 30 are attached to either side of the first pawl 25a (e.g. at shaft 26a) for holding the roller bearing 22. The roller bearing 22 is positioned between the arms 30 and mounted thereto by the mounting pin 22a acting as the fixed axis of rotation for the roller bearing 22, the mounting pin 22a projecting between the pair of arms 30 on either side of the body 30a of the first pawl 25a. The arms 30 are coupled to one another via the body 30a of the first pawl 25a (e.g. via the connector 45 and/or the pin 26a). Similar to the preceding embodiments referred to in FIGS. 2,3, the roller bearing 22 in the alternative embodiment of FIG. 7a can be positioned such that the bearing 22 can have a plurality of contacts (e.g. line contact) between an exterior surface of the roller bearing 22 and the surface(s) 34,36.

Referring to FIGS. 8a, 8b, 8c, 8d, shown is an alternative embodiment of the latch 20 having a single independent arm 30 for positioning the roller bearing 22 between the surfaces 34,36. Similarly to the embodiment shown in FIG. 6a, the arm 30 is attached to one side of the first pawl 25a (e.g. at shaft 26a) for holding the roller bearing 22 between the surfaces 34,36. The roller bearing 22 is positioned as extending from the single arm 30 and mounted thereto by the mounting pin 22a acting as the fixed axis of rotation for the roller bearing 22, the mounting pin 22a projecting from the single arm 30 positioned on one side of the body of the first pawl 25a. The arm 30 is coupled the body of the first pawl 25a (e.g. via the connector 45 and/or the pin 26a). Similar to the preceding embodiments referred to in FIGS. 2,3, the roller bearing 22 in the alternative embodiment of FIG. 8a can be positioned such that the roller bearing 22 can have a plurality of contacts (e.g. line contact) between an exterior surface 34a of the roller bearing 22 and the surface(s) 34,36.

As noted above for the ball bearing 22, it is recognized that the arm(s) 30, pin 22a and roller bearing 22 arrangement can be positioned on the ratchet 24 as desired, rather than the pawl 25, in order to position the roller bearing 22 between the surfaces 34,36.

In another embodiment, the bearing 22 may be provided on the second pawl 25b. In another possible configuration in accordance with the teachings herein, a bearing may be positioned between a ratchet and a primary pawl part of a double pawl, double ratchet (for example having a primary pawl mounted to an auxiliary ratchet which is blocked by a secondary pawl) configuration as shown for example in U.S. Pat. No. 10,563,435, the entire contents of which art incorporated herein by reference in its entirety.

We claim:

1. A latch comprising:
a housing having a slot for a striker;
a ratchet rotationally mounted on the housing and biased for release of the striker from the slot and retaining of the striker in the slot dependent upon angular position of the ratchet with respect to the housing, the ratchet having a ratchet surface;
a first pawl rotationally mounted on the housing, the first pawl having a pawl surface, the first pawl for holding the ratchet in an initial closed position when the first pawl is in an engaged position;
a second pawl rotationally mounted on the housing, the second pawl for maintaining the first pawl in the engaged position when the second pawl is engaged with the first pawl; and
a bearing positioned between the ratchet surface and the pawl surface such that contact between the ratchet and the first pawl is at one or more contact regions between an exterior surface of the bearing and adjacent respective at least one of the pawl surface or the ratchet surface.

2. The latch of claim 1, wherein the contact region is a localized contact region with respect to the exterior surface having a spheroidal shape.

3. The latch of claim 2, wherein an axis of rotation of the bearing varies in position as the bearing travels along at least one of the pawl surface and the ratchet surface.

4. The latch of claim 1, wherein the contact region is an elongated contact region with respect to the exterior surface having a cylindroid shape.

5. The latch of claim 2, wherein the spheroidal shape is a sphere.

6. The latch of claim 1, wherein the exterior surface of the bearing experiences rolling friction with respect to both the pawl surface as a cam surface and the ratchet surface as a cam surface during rotation of the pawl.

7. The latch of claim 1, further comprising a pawl lever coupled to the second pawl, the pawl lever when operated for releasing the second pawl from the initial closed position and thus disengaging the second pawl from the first pawl.

8. The latch of claim 7, wherein the first pawl is not assisted to move away from its engaged position other than by a force acting on the first pawl through the bearing when the second pawl is in the disengaged position.

9. The latch of claim 1, wherein the second pawl is rotationally biased towards its engaged position.

10. The latch of claim 9, wherein a spring member is provided between the second pawl and the first pawl to bias the first pawl away from the second pawl.

11. The latch of claim 1, wherein the first pawl is biased towards the engaged position.

12. The latch of claim 11, wherein disengaging the second pawl from the first pawl increases the bias urging the first pawl towards the engaged position.

13. The latch of claim 1, wherein the bearing is positioned between the ratchet and the first pawl by a bearing cage positioned on a body of the first pawl or on a body of the ratchet, the cage containing a bearing for rotation within the cage, such that contact between the ratchet and the first pawl is by one or more contact regions between an exterior surface of the bearing and adjacent respective at least one of the pawl surface or the ratchet surface.

14. The latch of claim 13, wherein an axis of rotation of the bearing varies in position as the bearing travels along a slot in one or more sidewalls of the bearing cage.

15. The latch of claim 13, further comprising a pair of opposed sidewalls of the bearing cage on the first pawl, each sidewall of the pair of opposed sidewalls being on an opposite side of a body of the ratchet such that a portion of the body of the ratchet overlaps a portion of the pair of opposed sidewalls during relative movement between the pawl and the ratchet.

16. The latch of claim 1, wherein the rotation of the bearing is induced by the rotation the first pawl when the second pawl is disengaged from the first pawl.

17. The latch of claim 16, wherein the rotation of the first pawl is induced by the ratchet imparting a force acting on the first pawl through the bearing.

18. A method for operating a latch comprising the steps of:
releasing a second pawl rotationally mounted on a housing, the second pawl for maintaining a first pawl in an initial closed position when the second pawl is engaged with the first pawl and for allowing rotation of the first pawl when the second pawl is disengaged from the first pawl;
rotating the first pawl, the first pawl having a pawl surface, the first pawl for holding a ratchet in the initial closed position when the first pawl is in an engaged position with the ratchet;
rotating a bearing positioned between the pawl surface and a ratchet surface, during rotation of the first pawl, such that contact between the ratchet and the first pawl is by one or more contact regions between an exterior surface of the bearing and adjacent respective at least one of the pawl surface or the ratchet surface; and
rotating the ratchet, the ratchet rotationally mounted on the housing and biased for release of a striker from the slot and retaining of the striker in the slot dependent upon angular position of the ratchet with respect to the housing, the ratchet having the ratchet surface.

19. The method of claim 18, further including rotating the first pawl as a result of a force imparted on the first pawl by the bearing caused by the ratchet acting on the bearing during rotating when the second pawl is disengaged from the first pawl.

20. The method of claim 19, further including inducing rotation of the bearing along the pawl surface cause by the rotating of the first pawl.
